(19) United States
(12) Patent Application Publication
(10) Pub. No.: US 2006/0287411 A1
(43) Pub. Date: Dec. 21, 2006

(54) Highly concentrated, storage stable aqueous dispersions for stabilizing coatings and glazes

(76) Inventor: Karl Bechtold, Schliengen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/552,603

(22) PCT Filed: Apr. 1, 2004
(86) PCT No.: PCT/IB04/01172

§ 371 Date: Oct. 7, 2005

(30) Foreign Application Priority Data
Apr. 7, 2003 (EP) 03007900.8

(51) Int. Cl. C09D 5/16

(52) U.S. Cl. 523/122

(57) ABSTRACT

Highly concentrated, storage stable aqueous dispersions of a light stabilizer or of a mixture of a light stabilizer and an antioxidant, having an active substance content of more than 47% by weight, which comprise at least one nonionic wetting agent as dispersant and a polyglycol as solubilizer, and also 0.2% to 5% by weight of oleic acid as flow improver. Further constituents can be anionic wetting agents and biocides. These dispersions of the invention can be incorporated easily into coating compositions, e.g., an aqueous dispersion, an aqueous emulsion or an aqueous solution of a binder based on crosslinkable alkyd resin, acrylic resin, polyester resin or polyurethane resin.

Public opinion and legislation are increasingly imposing the requirement on the handlers of coating materials to lessen the emissions of solvents. The reasons given for these strictures are on the one hand the increased environmental burden and on the other hand the occupational hygiene situation. Aqueous coating materials have in recent years acquired a continually growing position in the market. Cataphoretic dip priming and the waterborne surfacer are now state of the art for the coating of automobiles. Water-based coatings have obtained line approval in recent years, and even water-based clearcoats are now already being used on the line. Even transportation sealing systems and protective waxes are now being applied on an aqueous basis. In the segments, too, of the coating of externally mounted components made of plastic or metal, the coating of agricultural and construction machinery, office furniture, electrical or electronic devices, shelving components, lamps, and so on, water-based coating materials are nowadays already being employed.

Water-based coating systems and glazes in which either water-soluble binders or water-dilutable binders, or a combination of water-soluble and water-dilutable binders, are used are generally mixable only with stabilizers that are inherently liquid. The majority of commercially available stabilizers, however, are solid, pulverulent, and of poor solubility, if not insoluble, in water.

Liquid products, solutions or dispersions additionally have a range of advantages over the powder forms, such as absence of dusting during handling, absence of wetting problems due to lumping, and, not least, ease of metering in automatic installations, for example. In the course of storage over prolonged periods, however, the durability of liquid preparations is often unsatisfactory, and accordingly the formation of agglomerates or of a sediment is frequently observed. Inadequately dispersed particles are often the cause of frequent blockages in automated metering and mixing systems.

All organic materials, whether natural or synthetic, must normally be protected against breakdown by environmental effects and UV light, through the addition of stabilizers, in particular through the addition of light stabilizers and antioxidants.

Aqueous dispersions of light stabilizers, particularly of UV absorbers, have been known for some time already. Their use is prior art primarily in connection with the dyeing of synthetic fibers, especially unmodified or acid-modified polyester fibers. The concentration of the active components that are present in the corresponding commercial forms is generally in the region of well below 40 percent by weight. In addition, it is frequently found that the storage stability of the dispersion is not adequate, as is manifested by sedimentation of the active substances.

EP 225287 describes dye bath preparations comprising as further adjuvants, for stabilizability, electrolyte-sensitive thickeners, in order to allow a defined viscosity range to be maintained.

EP 345219 describes aqueous dispersions of 2-(2′-hydroxyphenyl)benzotriazoles for improving the light fastness of dyeings on synthetic fibers. A required adjuvant is an acidic ester or its salt with an alkylene oxide adduct.

EP 354174 describes aqueous compositions of 2-(2′-hydroxyphenyl)benzotriazoles for improving the light fastness of dyeings on synthetic fiber materials, especially unmodified or acid-modified polyester fibers. The preparations include as a further component a condensation product of a non-ether-bridged aromatic sulfonic acid and formaldehyde.

EP 468921 describes the production of an aqueous preparation of o-hydroxyphenyl-triazines for improving the light fastness of dyeings on synthetic fiber materials, especially polyester fibers.

EP 474595 describes aqueous dispersions of specially substituted 2-(2′-hydroxy-phenyl)benzotriazoles, alone or in a mixture with a benzophenone, for use in the dyeing of synthetic fiber materials, especially unmodified or acid-modified polyester fibers.

EP 490819 describes the aqueous preparation of a mixture of a benzotriazole compound and a 2-hydroxybenzophenone compound for use in the dyeing of synthetic fiber materials, especially unmodified or acid-modified polyester fibers.

EP 820978 describes the treatment of textile materials, to improve light stability, with aqueous preparations of 2-hydroxybenzophenone compounds.

DE-A 3511924 describes aqueous preparations of sterically hindered amine light stabilizers (HALS) for use in the coatings field, said preparations containing generally 5% to 50%, preferably 15% to 40% by weight of HALS and 2% to 30%, preferably 3% to 20% by weight of a nonionic dispersant. The active substance content used by way of example amounts to 32% by weight.

The dispersions prepared according to this laid-open specification, particularly those with relatively high active substance contents, however, are not sufficiently stable on storage to ensure a prolonged storage period without quality detractions.

GB 2 187 746 discloses stable aqueous dispersions of 2-(2′-hydroxyphenyl)benzo-triazoles (UV absorbers) having an active substance content of 20% to 45% by weight, and 7% to 15% by weight of a nonionic dispersant. The particle size of the UV absorber is preferably <1 μm. The active substance contents used by way of example amount to 40% by weight.

DE-A 19946519 discloses, very generally, aqueous dispersions for stabilizing polymeric dispersions, and also a process for preparing them. The active substance content (amount of phenolic antioxidant) is defined as being from 0.1% to 59.9% by weight, the fraction of surface-active substances for dispersing as being from 0.5% to 15% by weight.

The object of the present invention was to improve the storage stability of highly concentrated aqueous dispersions of a light stabilizer or of a mixture of a light stabilizer and an antioxidant.

The object is achieved in accordance with the invention by means of aqueous dispersions of a light stabilizer or of a mixture of a light stabilizer and an antioxidant, characterized in that they have an active substance content of more than 47% by weight and comprise at least one nonionic wetting agent as dispersant and a polyglycol as solubilizer, and also 0.2% to 5% by weight of oleic acid as flow improver.

The object is also achieved, further, by a method of stabilizing aqueous dispersions using the abovementioned components.

The present invention provides dispersions of individual or mixed light stabilizers and antioxidants and provides for their use in the stabilizing of coatings and glazes, especially water-based basecoats, clearcoats, and glazes. The invention relates in particular to storage stable aqueous preparations of solids that are of poor to zero solubility in water and are used as light stabilizers or antioxidants, with a particle size D₅₀ of less than 5 μm, for stabilizing water-based coating systems and glazes. The active substances preferably have a particle size of D₅₀=0.5-2 μm and D₉₀<3.5 μm.

The invention is characterized in that the highly concentrated, storage stable aqueous dispersions have an active substance content of more than 47% by weight, preferably 47%-57% by weight, more preferably 47%-54% by weight, and very preferably of more than 50% and up to 54% by weight.

The highly concentrated aqueous dispersions of the invention contain 0.2%-5.0% by weight of oleic acid as flow improver, to ensure an appropriate viscosity without excessive dilution. Preference is given to using amounts of 0.2%-4.0% by weight and with particular preference of 0.2%-3.0% by weight.

The aqueous dispersions preferably have a viscosity of 0.01 to 2 Pa s.

Besides nonionic wetting agent, the highly concentrated aqueous dispersions of the invention preferably also include an anionic wetting agent, which permits optimum dispersing of the active substances and thus ensures improved storage stability.

The light stabilizer, or the mixture of a light stabilizer and an antioxidant, in accordance with the invention, ought to have a melting point of at least 35° C. in order that they do not melt in the course of processing to aqueous dispersions, which frequently take place at an elevated temperature.

Preferred light stabilizers are the products with the formulae I to VIII

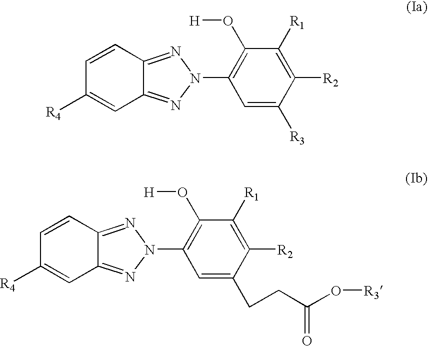

(solid products as described for example in U.S. Pat. No. 4,853,471)

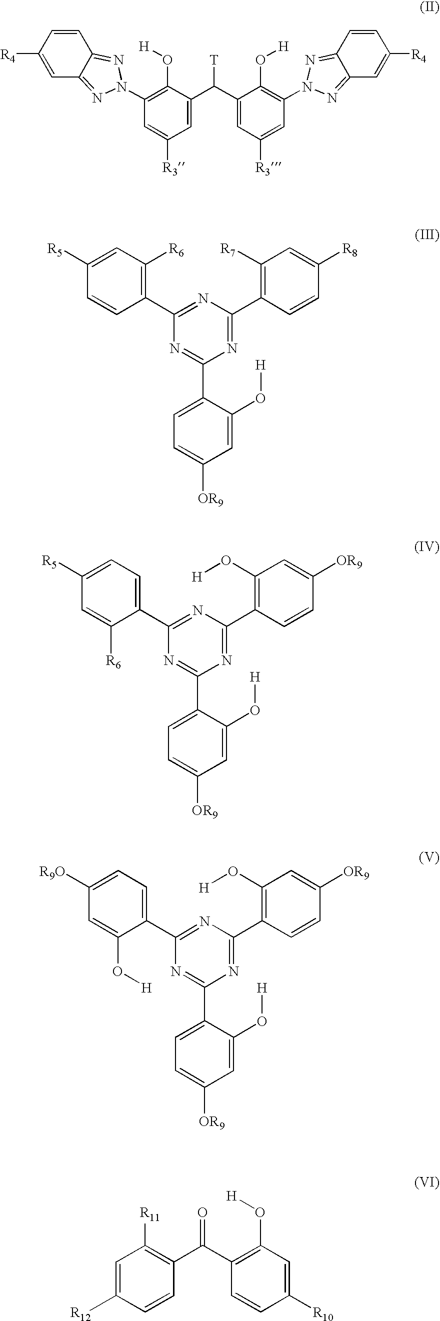

(as described for example in EP 820 978 A1) 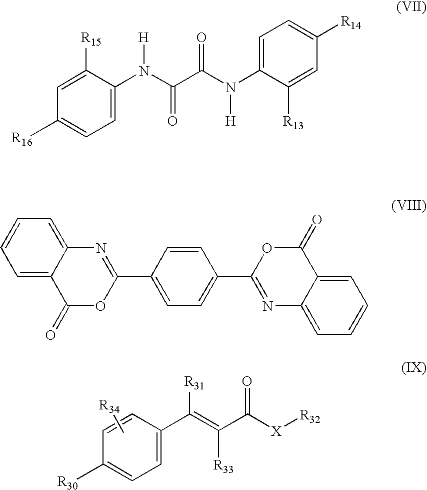
in which

R₃₀ is H, n-alkyl, isoalkyl, unsubstituted or substituted aryl, OR₃₅, or a structural component

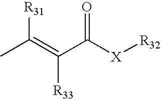

where R₃₅ is H, n-alkyl, isoalkyl, unsubstituted or substituted aryl,

R₃₁ is H, n-alkyl, isoalkyl or a structural component 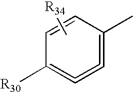
X is —O— or —(NR₃₆)—

where R₃₆=H, n-alkyl, isoalkyl
R₃₃=is H, n-alkyl, isoalkyl, CN or a group 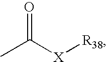
where X being as described above, and

R₃₂ and R₃₈ independently have the following definitions:
H, n-alkyl, isoalkyl, unsubstituted and substituted aryl, or a structural component 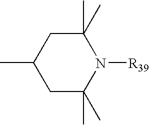
where R₃₉=H or C₁-C₁₈ alkyl, C₇-C₁₈ alkylaryl, —O—C₁-C₁₈ alkyl, or acetyl.

The symbols R₁ to R₁₆ have the following definitions:

R₁, R₂, and R₃ independently of one another are hydrogen, linear or branched C₁-C₁₂ alkyl, cycloalkyl, aralkyl; preferably methyl, sec-butyl, tert-butyl, tert-amyl, tert-octyl, cyclohexyl or a group

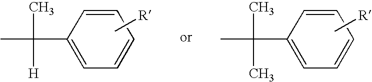

in which R′ is hydrogen or C₁-C₁₂ alkyl.

R₄ is hydrogen, halogen such as Cl or Br, carboxyl or a sulfonic acid group, linear or branched C₁-C₁₂ alkyl, cycloalkyl or lower alkoxy;

R₃′, R₃″, and R₃′″ independently of one another are hydrogen, linear or branched C₁-C₁₂ alkyl, cycloalkyl, aralkyl;

T is hydrogen, C₁-C₁₂ alkyl or an oxo group;

R₅, R₆, R₇, and R₈ independently of one another are hydrogen, linear or branched C₁-C₈ alkyl, unsubstituted aryl or lower alkyl-substituted aryl;

R₉ is hydrogen or a linear or branched, aliphatic or cycloaliphatic alkyl group with C₁-C₁₂ which optionally can be substituted by one or more OH groups or one or more alkoxy groups or mixedly by OH groups and alkoxy groups.

R₁₀ is OH, alkoxy with C₁-C₁₂, hydroxyethoxy or a group

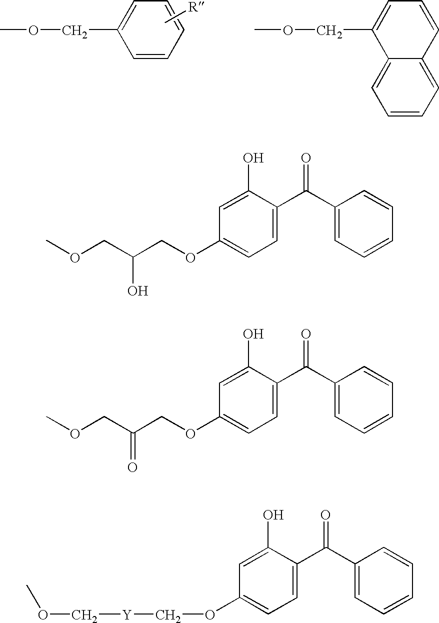

in which Y is a direct bond or a group 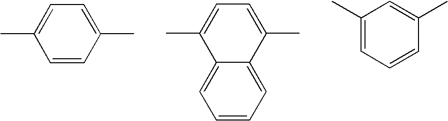
and in which R″ is hydrogen, methyl or methoxy,

R₁₁ is hydrogen, halogen, cyano, C₁-C₈ alkyl, cycloalkyl, alkoxy, phenoxy, phenyl, hydroxy or hydroxyethoxy;

R₁₂ is hydrogen, halogen, cyano, C₁-C₈ alkyl, cycloalkyl, alkoxy, phenoxy, phenyl, hydroxy or hydroxyethoxy or a group

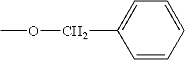

R₁₃, R₁₄, R₁₅, and R₁₆, identically or independently of one another, are hydrogen, linear or branched alkyl, OH or alkoxy.

The sterically hindered piperidine derivatives (HA(L)S) employed in accordance with the invention belong to the well-known group of stabilizers which are already used for improving light fastness or mechanical properties. Examples of sterically hindered piperidine derivatives of this kind are those of the formulae (IXa)-(IXc) 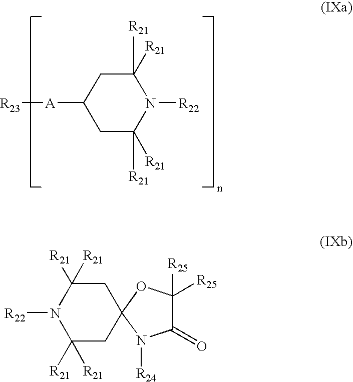
reaction products of 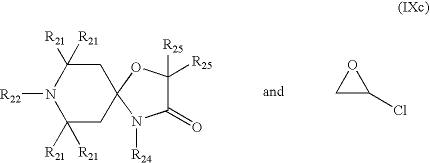
in which, independently of one another,

A is —O— or —NR₂₀—,

R₂₀ is H, C₁-C₁₈ alkyl or one of the groups

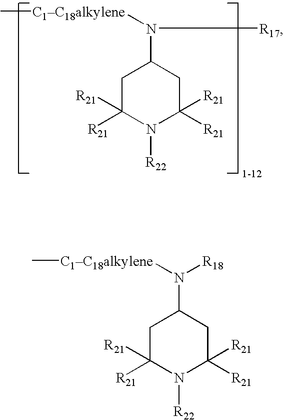

R₁₇ is H or C₁-C₁₈ alkyl,

R₁₈ is H or an aliphatic, cycloaliphatic, aromatic or heteroaromatic radical,

R₂₁ is C₁-C₁₈ alkyl,

or two radicals R₂₁attached to the joint carbon atom are a C₄-C₈ cycloalkyl radical,

R₂₂ is H or C₁-C₁₈ alkyl, C₇-C₁₈ alkylaryl,

R₂₃ is H or an n-valent aliphatic, cycloaliphatic, aromatic or heteroaromatic radical,

R₂₄ is C₁-C₁₈ alkyl or —C(O)—C₁-C₁₈ alkyl;

R₂₅ is H, C₁-C₁₈ alkyl, C₄-C₁₈ cycloalkyl, or two radicals R₅ attached to the same carbon atom are a C₄-C₁₈ cycloalkyl radical,

n is an integer >0.

As further additive the following antioxidants may be present in the dispersions of the invention:

1.1 alkylated monophenols, e.g., 2,6-di-tert-butyl-4-methylphenol, 2-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 24a-methylcyclohexyl)-4,6-dimethylphenol, 2,6-dioctadecyl-4-methylphenol, 2,4,6-tricyclohexylphenol, 2,6-di-tert-butyl-4-methoxymethylphenol, 2,6-dinonyl-4-methylphenol, 2,4dimethyl-6-(1′-methylundec-1′-yl)phenol, 2,4-dimethyl-6-(1′-methylheptadecyl)phenol, 2,4-dimethyl-6-(1′-methyltridec-1′-yl)phenol, and mixtures thereof.

1.2 alkylthiomethylphenols, e.g., 2,4-dioctylthiomethyl-6-tert-butylphenol, 2,4-dioctyl-thiomethyl-6-methylphenol, 2,4-dioctylthiomethyl-6-ethylphenol, 2,6-didodecyl-thiomethyl-4-nonylphenol.

1.3 hydroquinones and alkylated hydroquinones, e.g., 2,6-di-tert-butyl-4-methoxy-phenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-d i-tert-butyl-4-hydroxyphenyl stearate, bis(3,5-di-tert-butyl-4-hydroxyphenyl) adipate.

1.4 tocopherols, e.g., α-tocopherol, β-tocopherol, γ-tocopherol, δ-tocopherol, and mixtures thereof (vitamin E).

1.5 hydroxylated thiodiphenyl ethers, e.g., 2,2′-thiobis(6-tert-butyl-4-methylphenol), 2,2′-thiobis(4-octylphenol), 4,4′-thiobis(6-tert-butyl-3-methylphenol), 4,4′-thiobis(6-tert-butyl-2-methylphenol), 4,4′-thiobis(3,6-di-sec-amylphenol), 4,4′-bis(2,6-dimethyl-4hydroxyphenyl) disulfide.

1.6 alkylidene bisphenols, e.g., 2,2′-methylenebis(6-tert-butyl-4-methylphenol), 2,2′-methylenebis(6-tert-butyl-4-ethylphenol), 2,2′-methylenebis[4-methyl-6-(α-methyl-cyclohexyl)phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2.2′-ethylidenebis(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-1-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methyl-phenyl)butane, 1,1-bis(5-tert-butyl-4-hydroxy-2-methylphenyl)-3-n-dodecyl-mercaptobutane, ethylene glycol bis[3,3-bis(3′-tert-butyl-4′-hydroxyphenyl)-butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl] terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)-pentane.

1.7 O—, N—, and S-benzyl compounds, e.g., 3,5,3′,5′-tetra-tert-butyl-4,4′-dihydroxy-dibenzyl ether, octadecyl 4-hydroxy-3,5-dimethylbenzylmercaptoacetate, tris(3,5-di-tert-butyl-4-hydroxvbenzyl)amine, bis(4-tert-butyl-3-hydroxy-2,6-dimethyl-benzyl) dithioterephthalate, bis(3,5-di-tert-butyl-4-hydroxybenzyl) sulfide, isooctyl 3,5-di-tert-butyl-4-hydroxybenzylmercaptoacetate.

1.8 hydroxybenzylated malonates, e.g., dioctadecyl 2,2-bis(3,5-di-tert-butyl-2-hydroxybenzyl)malonate, dioctadecyl 2-(3-tert-butyl-4-hydroxy-5-methylbenzyl)-malonate, didodecyl mercaptoethyl-2,2-bis(3,5-di-tert-butyl-4-hydroxybenzyl)-malonate, di[4-(1,1,3,3-tetramethylbutyl)phenyl]2,2-bis(3,5-di-tert-butyl-4-hydroxybenzyl)malonate.

1.9 aromatic hydroxybenzyl compounds, e.g., 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.10 triazine compounds, e.g., 2,4-bisoctylmercapto-6-(3,5-di-tert-butyl-4-hydroxy-anilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxyphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl)isocyanurate.

1.11 benzylphosphonates, e.g., dimethyl 2,5-di-tert-butyl-4-hydroxybenzylphos-phonate, diethyl 3,5-di-tert-butyl-4-hydroxybenzylphosphonate, dioctadecyl 3,5-di-tert-butyl-4-hydroxybenzyl phosphonate, dioctadecyl 5-tert-butyl-4-hydroxy-3-methylbenzylphosphonate, Ca salt of monoethyl 3,5-di-tert-butyl-4-hydroxybenzylphosphonate.

1.12 acylaminophenols, 4-hydroxylauramide, 4-hydroxystearanilide, octyl N-(3,5-di-tert-butyl-4-hydroxyphenyl)carbamate.

1.13 esters of β-(3,5-di-tert-butyl-4-hydroxyphenyl)propionic acid with mono- or polyhydric alcohols, e.g., with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14 esters of β-(5-tert-butyl-4-hydroxy-3-methylphenyl)propionic acid with mono- or polyhydric alcohols, e.g., with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy)ethylisocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane. 1.15 esters of β-(3,5-dicyclohexyl-4-hydroxyphenyl)propionic acid with mono- or polyhydric alcohols, e.g., with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy)ethylisocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16 esters of 3,5-di-tert-butyl-4-hydroxyphenylacetic acid with mono- or polyhydric alcohols, e.g., with methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxy)ethylisocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane. 1.17 amides of β-(3,5-di-tert-butyl-4-hydroxyphenyl)propionic acid, such as N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

Further additives which may be present in the dispersions of the invention are as follows:

2. metal deactivators, such as N,N′-diphenyloxalamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyl dihydrazide, oxanilide, isophthaloyl dihydrazide, sebacoyl bisphenylhydrazide, N,N′-diacetyladipoyl dihydrazide, N,N′-bissalicyloyloxalyl dihydrazide, N,N′-bissalicyloylthiopropionyl dihydrazide.

3. phosphites and phosphonites, such as triphenyl phosphite, diphenylalkyl phosphites, phenyl dialkyl phosphites, tris(nonylphenyl) phosphite, trilauryl phosphite, trioctadecyl phosphite, distearyl pentaerythritol diphosphite, tris(2,4-di-tert-butylphenyl) phosphite, diisodecyl pentaerythritol diphosphite, bis(2,4-di-tert-butylphenyl) pentaerythritol diphosphite, bis(2,6-di-tert-butyl-4-methylphenyl) pentaerythritol diphosphite, bis-isodecyloxy-pentaerythritol diphosphite, bis(2,4-di-tert-butyl-6-methylphenyl) pentaerythritol diphosphite, bis(2,4,6-tri-tert-butylphenyl) pentaerythritol diphosphite, tristearylsorbitol triphosphite, tetrakis(2,4-di-tert-butylphenyl) 4,4′-biphenylene diphosphonite, 6-isooctyloxy-2,4,8,1 0-tetra-tert-butyl-12H-dibenzo[d,g]-1,3,2-dioxaphosphocine, 6-fluoro-2,4,8,10-tetra-tert-butyl-12-methyidibenzo[d,g]-1,3,2-dioxaphosphocine, bis(2,4-di-tert-butyl-6-methylphenyl) methyl phosphite, bis(2,4-di-tert-butyl-6-methylphenyl) ethyl phosphite.

4. peroxide scavenger compounds, such as esters of β-thiodipropionic acid, examples being the lauryl, stearyl, myristyl or tridecyl esters, mercaptobenz-imidazole, the zinc salt of 2-mercaptobenzimidazole, zinc dibutyidithiocarbamate, dioctadecyl disulfide, pentaerythritol tetrakis(β-dodecylmercapto)propionate.

5. polyamide stabilizers, such as copper salts in combination with iodides and/or phosphorus compounds, and salts of divalent manganese.

6. basic co-stabilizers, such as melamine, polyvinylpyrrolidone, dicyandiamide, triallyl cyanurate, urea derivatives, hydrazine derivatives, amines, polyamides, polyurethanes, alkali metal salts and alkaline earth metal salts of higher fatty acids, examples being Ca stearate, Zn stearate, Mg behenate, Mg stearate, Na ricinoleate, K palmitate, antimony pyrocatecholate or tin pyrocatecholate.

7. nucleating agents, such as 4-tert-butylbenzoic acid, adipic acid, diphenyl acetic acid.

8. fillers and reinforcing agents, such as calcium carbonate, silicates, glass fibers, asbestos, talc, kaolin, mica, barium sulfate, metal oxides, metal hydroxides, carbon black, graphite.

9. other adjuvants, such as plasticizers, lubricants, emulsifiers, pigments, optical brighteners, flame retardants, antistats, blowing agents.

The highly concentrated aqueous dispersions of the invention have a storage stability of more than 4 weeks at 50° C., which experience indicates corresponds to a storage of more than 1 year at room temperature.

In one preferred embodiment the aqueous dispersions of the invention include a biocide as a further component. The presence of a biocide further considerably increases the storage stability, since the decomposition (or partial degradation) of the dispersant and/or of the light stabilizers through fungal and/or bacterial infestation is prevented or at least greatly slowed.

Biocides are, for example, compounds from the class of the derivatized isothiazolin-3-ones. They are used in the form of their solutions, emulsions, or as synergistic mixtures with other components. Preference is given to commercially customary biocides such as, for example, the commercial products ACTICIDE® from Thor or PARMETOL® from Schülke & Mayr.

Particularly preferred aqueous dispersions in accordance with the invention contain 47%-54% by weight active substance, 5%-10% by weight wetting agents, 5%-10% by weight solubilizers, 0.2%-3% by weight oleic acid, and <1 % by weight biocides, in 30%-40% by weight water.

The stabilizer preparations of the invention can be prepared by dispersing the stabilizer in the form of a powder, compact or granules in the presence of the oleic acid, the polyglycol and dispersant and/or further customary additives. The dispersant and/or additives are preferably first mixed with the oleic acid, the stabilizer is incorporated with stirring, and, depending on the harshness of the particulate nature of the stabilizer employed, the mixture is dispersed using agitator mechanisms, dissolvers, rotor-stator mills, bore mills, agitator-mechanism bore mills, such as sand mills and bead mills, high-speed mixers, kneading apparatus or high-power bead mills. The preparation obtained is optionally diluted further with oleic acid.

The highly concentrated aqueous dispersions of the invention are incorporated into aqueous coating compositions, where they are used in amounts of 0.3% to 3% by weight of the overall formula and are compatible with all known binder systems. Examples of such systems are aqueous dispersions, aqueous emulsions or aqueous solutions of a binder based on crosslinkable alkyd resin, acrylic resin, polyester resin or polyurethane resin.

The examples below use the following products:

UVA 1=Tinuvin® 326 2-(2′-hydroxy-3′-tert-butyl-5′-methylphenyl)-5-chlorobenzotriazole

UVA 2=Tinuvin® P 2-(2′-hydroxy-5′-methylphenyl)benzotriazole

UVA 3=Tinuvin® 328 2-(2′-hydroxy-3′,5′-di-tert-amylphenyl)benzotriazole

UVA 4=Tinuvin® 329 bis-[2-hydroxy-5-tert-octyl-3-(benzotriazol-2-yl)-phenyl]methane

UVA 5=Cyasorb® 1164 P 2-[4,6-bis(2,4-dimethylphenyl)-1,3,5-triazin-2-yl]-5-(octyloxy)phenol

UVA 6=Tinuvin® 405 2-[4,6-bis(2,4-dimethylphenyl)-1,3,5-triazin-2-yl]-5-[3-[(2-ethylhexyl)oxy]-2-hydroxypropoxy]phenol

UVA 7=Tinuvin® 1577 2-(4,6-diphenyl-1,3,5-triazin-2-yl)-5-hexyloxyphenol

UVA 8=Sanduvor® 3041 2-hydroxy-4-methoxybenzophenone

UVA 9=Uvinu® 3040 2,2′-dihydroxy-4-methoxybenzophenone

UVA 10=Sanduvor® 3035 2-hydroxy-4-n-octyloxybenzophenone

UVA 11=Sanduvor® VSU N-(2-ethoxyphenyl)-N′-(2-ethylphenyl)ethanediamide

UVA 12=Sanduvor® EPU N-(2-ethoxy-5-tert-butylphenyl)-N′-(2-ethylphenyl)-ethanediamide

UVA 13=Cyasorb® UV-3638 2,2′-(1,4-phenylene)bis[4H-3,1 -benzoxazin-4-one]

UVA 14 methyl cinnamate

UVA 15=Uvinul® 3035 ethyl 2-cyano-3,3-diphenylacrylate

UVA 16 =Hostavin® B-CAP tetraethyl 2,2′-bis(1,4-phenylenedimethylidene)-malonate

UVA 17=Cyasorb® UV-3346 poly[(6-morpholino-s-triazine-2,4-diyl)[2,2,6,6-tetra-methyl-4-piperidyl)imino]hexamethylene[(2,2,6,6-tetramethyl-4-piperidyl)imino]]

HALS 1=Tinuvin® 770 bis(2,2,6,6-tetramethyl-4-piperidyl) sebacate

HALS 2=Tinuvin® 144 bis(1,2,2,6,6-pentamethyl-4-piperidyl) (3,5-di-tert-butyl-4-hydroxybenzyl)butylpropanedioate

HALS 3=Sanduvore PR-31 propanedioic acid, [(4-methoxyphenyl)methylene]-bis(1,2,2,6,6-pentamethyl-4-piperidinyl) ester

HALS 4=Sanduvor® 3051 2,2,4,4-tetramethyl-7-oxa-3,20-diazadispiro-[5.1.11.2]heneicosan-21-one

HALS 5=Hostavin® N30 polymer from the reaction of 2,2,4,4-tetramethyl-7-oxa-3,20-diazadispiro{5.1.11.2]heneicosan-21 -one with epichlorohydrin

HALS 6=Chimassorb® 944 poly[(6-isooctylamino-s-triazine-2,4-diyl)[2,2,6,6-tetramethyl-4-piperidyl)imino]hexamethylene-[(2,2,6,6-tetramethyl-4-piperidyl)imino]]

HALS 7=Chimassorb® 119 1,3,5-triazine-2,4,6-triamine, N,N′″-[1,2-ethanediyl-bis[[[4,6-bis[butyl(1,2,2,6,6-pentamethyl-4-piperidinyl)amino]-1,3,5-triazin-2-yl]imino]-3,1-propanediyl]]bis[N′,N″-dibutyl-N′,N″-bis(1,2,2,6,6-pentamethyl-4-piperidinyl)

HALS 8 4-hydroxy-2,2,6,6-tetramethylpiperidinyl-1-oxy

Dispersant mixture M1 oleyl-8-ethoxylate+tetrasodium N-(1,2-dicarboxyethyl)-N-octadecylsulfosuccinamate

Dispersant mixture M2 oleyl-10-ethoxylate+tetrasodium N-(1,2-dicarboxyethyl)-N-octadecylsulfosuccinamate

The polyglycol used is a polyethylene glycol monomethyl ether having an average mass in the range 470-530 g/mol.

### EXAMPLE 1

In a vertical mill
10 parts of polyglycol
8.5 parts of a dispersant mixture M1
1.0 part of oleic acid and
0.2 part of a biocide are mixed in 32.3 parts of water.

Then 48 parts of UVA 1 are added and the mixture is ground with glass beads (diameter 1 mm) for 5-6 hours until the particle size is <5 μm. The dispersion thus obtained is separated from the beads by filtration. This gives a storage stable dispersion (viscosity 1.0 Pas).

### EXAMPLE 2

By the same process,
20 parts of polyglycol
6 parts of dispersant mixture M2
1.0 part of oleic acid and
0.2 part of a biocide are mixed in 24.8 parts of water, and 48 parts of UVA 1 are added. This gives a storage stable dispersion (viscosity 1.8 Pas).

### EXAMPLE 3

By the same process,
5 parts of polyglycol
6 parts of dispersant mixture M2
1.0 part of oleic acid and
0.2 part of a biocide are mixed in 39.8 parts of water, and 48 parts of UVA 1 are added. This gives a storage stable dispersion (viscosity 0.8 Pas).

### EXAMPLE 4

By the same process,
10 parts of polyglycol
6 parts of dispersant mixture M2
1.0 part of oleic acid and
0.2 part of a biocide are mixed in 30.8 parts of water, and 52 parts of UVA 2 are added. This gives a storage stable dispersion (viscosity 0.7 Pas).

### EXAMPLE 5

By the same process,
5 parts of polyglycol
6 parts of dispersant mixture M2
1.0 part of oleic acid and
0.2 part of a biocide are mixed in 39.8 parts of water, and 48 parts of UVA 3 are added. This gives a storage stable dispersion (viscosity 0.2 Pas).

### EXAMPLE 6

By the same process,
5 parts of polyglycol
6 parts of dispersant mixture M2
1.0 part of oleic acid and
0.2 part of a biocide are mixed in 37.8 parts of water, and 50 parts of UVA 4 are added. This gives a storage stable dispersion (viscosity 0.4 Pas).

### EXAMPLES 7-28

By the same process, in accordance with Example 3 or 5 respectively,
5 parts of polyglycol
6 parts of dispersant mixture M2
1.0 part of oleic acid and
0.2 part of a biocide

are mixed in 37.8 parts of water, and 48 parts of the following stabilizers are added:

### EXAMPLE 7

### UVA 5

### EXAMPLE 8

### UVA6

### EXAMPLE 9

### UVA7

### EXAMPLE 10

### UVA 8

### EXAMPLE 11

### UVA9

### EXAMPLE 12

### UVA10

### EXAMPLE 13

### UVA11

### EXAMPLE 14

### UVA12

### EXAMPLE 15

### UVA13

### EXAMPLE 16

### UVA 14

### EXAMPLE 17

### UVA 15

### EXAMPLE 18

### UVA 16

### EXAMPLE 19

### HALS 1

### EXAMPLE 20

### HALS 2

### EXAMPLE 21

### HALS 3

### EXAMPLE 22

### HALS 4

### EXAMPLE 23

### HALS 5

### EXAMPLE 24

### HALS 6

### EXAMPLE 25

### HALS 7

### EXAMPLE 26

### UVA 17

### EXAMPLE 27

### HALS 4+HALS 8

### EXAMPLE 28

### HALS 4+UVA 11

Demonstration of Improved Storage Stability

A sample of each of the dispersions prepared according to DE-A 3511924 Example 1 and Example 2 is tested with the dispersions according to the above-described Examples 22 and 27, respectively, in respect of their storage stabilities at room temperature and 50° C. The measure taken for the stability is the time after which the products begin to settle:

| | Storage | |
|---|---|---|
| | at room | Storage at |
| | temperature | 50° C. |
| DE-A 3511924 Example 1 | 8-9 weeks | 6 weeks |
| (active substance content 32% by weight) | | |
| Example 22 | 22 weeks | 18-19 weeks |
| (active substance content 48% by weight) | | |
| DE-A 3511924 Example 2 | 12 weeks | 8-9 weeks |
| (active substance content 32% by weight) | | |
| Example 27 | 24 weeks | 20 weeks |
| (active substance content 48% by weight) | | |

Demonstration of Improved Storage Stability Through Addition of a Biocide

Examples 1 to 6 are repeated without a biocide in the formula (Examples 1a to 6a).

After 6 months' storage at room temperature the specimens are investigated for fungal and bacterial infestation.

The test system used is from the company Biotest Diagnostics GK-T/HS, allowing simultaneous determination of the total microbial count/TTC on one side and of the yeasts and molds on the other side. For this purpose, the dispersions are applied slowly dropwise over both sides of the indicator surfaces, so that the surfaces are wetted, or they are brushed with a sterile inoculation loop immersed in the dispersions. The tubes are subsequently sealed and incubated in an incubator at 30-35° C. for 3-5 days. In accordance with the instructions accompanying each pack, the indicators are evaluated by comparison. If after the appropriate incubation time there are more than 10² CFU/ml (CFU=colony forming units) present, then there is severe contamination of the dispersion, which may have a strongly negative influence on the further storage stability of the dispersion (degradation of the dispersant).

| With biocide | CFU | Without biocide | CFU |
|---|---|---|---|
| Example 1 | <10² | Example 1a | >=10⁵ |
| Example 2 | <10² | Example 2a | >10⁴ |
| Example 3 | <10² | Example 3a | >10³ |
| Example 4 | <10² | Example 4a | >10³ |
| Example 5 | <10² | Example 5a | >10⁴ |
| Example 6 | <10² | Example 6a | >10³ |

### Application Example

A water-based resin system consisting of a styrene-modified acrylate emulsion is prepared as follows: a mixture consisting of
106.0 parts of butylglycol and
132.1 parts of demineralized water is added with thorough stirring and slowly to
761.9 parts of Neocryl® XK-62 (Avecia).

This system serves in the further experiments as base material for testing the dispersions cited in the examples in respect, for example, of clear solubility, which is an indicator of good compatibility and distribution.

The “coating materials” stabilized in this way are applied using a doctor blade (film width 80 mm) at 100 μm wet film thickness to highly transparent polyester films and/or matt black-pigmented LENETA charts, and dried in a forced-air oven at 50° C. and 80° C. Thereafter the polyester films are inspected for transparency, the LENETA charts for any blooming, which represents an indicator of incompatibility and saturation in the coating material.

Application in an Aqueous 2K [2-Component] PU Clearcoat for OEM Applications

The polyol component is put together on the basis of the following ingredients:

| | | |
|---|---|---|
| Bayhydrol ® VP LS 2271 | 28.33 | (Bayer) |
| Bayhydrol ® VP LS 2231 | 31.03 | (Bayer) |
| Byk ® 345 as-supplied form | 0.29 | (Byk Chemie) |
| Byk ® 333 25% in water | 0.28 | (Byk Chemie) |
| Distilled water | 12.86 | |

The polyol component is stirred up intensively by hand or using a high-speed stirrer (1000 rpm). The individual ingredients should be mixed in the predetermined order.

Curing Component

| | | |
|---|---|---|
| Desmodur ® N 3600 | 17.28 | (Bayer) |
| Butylglycol acetate/Solvesso ® 100 (1:1) | 7.33 | (Exxon Mobile) |

Prior to mixing with the curing component, the dispersions described in the examples are added to the polyol component. Mixing with the curing component should not take place any earlier than 12 hours after the preparation of the polyol component. Mixing of the polyol component with the curing component is accomplished in 2 steps:
1) by preparing a preliminary emulsion by stirring together with components by hand or
2) laboratory stirrer

Final mixing is accomplished by jet dispersion at 50 bar (e.g., airless pump Merkur 060.020-DP F, Walther, Wuppertal) or using a Dispermate (5 min at 2000 rpm).

Comparative experiments by addition of liquid HALS stabilizers based on butylglycol to the resin solution:

Tinuvin® 292 (Ciba) severe gelling after a short time

Sanduvor® 3052 (Clariant) severe gelling after a short time

Application in a Soft-Feel Coating

The soft-feel coating material is prepared as follows:

| Item | Raw material | Amount | Description |
|---|---|---|---|
| 1 | CUR 21 | 54.70 | Binder (Alberdingk-Boley) |
| 2 | Byk 024 | 0.60 | Defoamer (Byk Chemie) |
| 3 | Dow Corning 67 | 0.40 | Wetting agent (Dow Corning) |
| 4 | Byk 044 | 0.20 | Defoamer (Byk Chemie) |
| 5 | Worlée-Pol 1181/03 | 5.00 | Polyester (Worlée) |
| 6a | Butylglycol* | 3.50 | Solvent (BASF) |
| 6b | Water* | 30.00 | Solvent |
| 7 | Acematt TS-100 | 1.50 | Matting agent (Degussa) |
| 8 | DSX 1514 | 0.10 | Rheology additive (Cognis) |
| 9 | Colanyl black N230 | 4.00 | Pigment preparation (Clariant) |
| | | 100.00 | |

*= Mix before use!

Added to this coating material is 0.5% by weight of the above-described dispersion. The “coating materials” thus stabilized are applied using a doctor blade (film width 80 mm) at a wet film thickness of 100 μm to highly transparent polyester films, and dried at room temperature and at 50° C. in a forced-air oven. Thereafter the polyester films are tested for transparency.

1. A highly concentrated, storage stable aqueous dispersion comprising a light stabilizer or a mixture of a light stabilizer and an antioxidant, at least one nonionic wetting agent as a dispersant, a polvglycol as a solubilizer, and 0.2% to 5% by weight of oleic acid as a flow improver, wherein the aqueous dispersion has an active substance content of more than 47% by weight.

2. The aqueous dispersion of claim 1, wherein the light stabilizer or the mixture of a light stabilizer and an antioxidant has a melting point of at least 35° C.

3. The aqueous dispersion of claim 1, wherein the active substance content is from 47% to 57% by weight.

4. The aqueous dispersion of claim 1, wherein the aqueous dispersion has a viscosity of 0.01 to 2 Pa s.

5. The aqueous dispersion of claim 1, further comprising an anionic wetting agent.

6. The aqueous dispersion of claim 1, wherein the active substances of the aqueous dispersion have a particle size of D₅₀<5 μm.

7. The aqueous dispersion of claim 1, having a storage stability of more than 4 weeks at 50° C.

8. The aqueous dispersion of claim 1, further comprising a biocide.

9. The aqueous dispersion of claim 1, comprising:
47%-54% by weight active substance content,
5%-10% by weight of the dispersant,
5%-10% by weight of the solubilizer,
0.2%-3% by weight of the flow improver,
<1% by weight of at least one biocide, and
30%-40% by weight water.

10. A method of improving the storage stability of an aqueous dispersion of a light stabilizer or of a mixture of a light stabilizer and an antioxidant, comprising the steps of mixing a dispersant, a solubilizer, and optionallv, at least one additive, with oleic acid to form a first mixture and adding the light stabilizer or the mixture of a light stabilizer and an antioxidant to the first mixture, wherein the light stabilizer or the mixture of a light stabilizer and an antioxidant is in the form of a powder, compact or granules, and dispersing the light stabilizer or the mixture of a light stabilizer and an antioxidant in the first mixture.

11. A method of using an aqueous dispersion of claim 1, comprising the step of adding the aqueous dispersion to a coating composition during the preparation of the coating composition.

12. A coating composition in the form of an aqueous dispersion comprising an aqueous dispersion of claim 1 and an aqueous dispersion, an aqueous emulsion or an aqueous solution of a binder based on crosslinkable alkyd resin, acrylic resin, polyester resin or polyurethane resin.

13. The aqueous dispersion of claim 1, wherein the active substances of the aqueous dispersion have a particle size of D₅₀=0.5-2 μm and D₉₀<3.5 μm.

14. An aqueous dispersion made in accordance with the method of claim 10.

15. A coating composition comprising an aqueous dispersion as claimed in claim 1.
